(19) United States
(12) Patent Application Publication
(10) Pub. No.: US 2003/0088685 A1
(43) Pub. Date: May 8, 2003

(54) Apparatus and method for controlling QoS in ATM

(75) Inventor: Byung-Cheon Lee, Kyungki-Do (KR)

Correspondence Address: FLESHNER & KIM, LLP, 14500 AVION PARKWAY, SUITE 125, CHANTILLY, VA, 20151, US

(73) Assignee: LG Electronics Inc.

(21) Appl. No.: 10/285,432

(22) Filed: Nov. 1, 2002

(30) Foreign Application Priority Data
Nov. 7, 2001 (KR) 69192/2001

(51) Int. Cl. G06F 15/16; G06F 15/173

(52) U.S. Cl. 709/230; 709/224; 709/246

(57) ABSTRACT

An apparatus for controlling QoS of an ATM includes a first processing unit converting received AAL5-type traffic into AAL2-type traffic, and after that, serving real-time AAL2-type traffic with priority; and a second processing unit converting received AAL2-type traffic into AAL5-type traffic, and after that, serving real-time AAL5-type traffic with priority. Therefore, when a transmission link failure or traffic congestion is generated, real-time service traffic and non-real-time service traffic is segmented, and the real-time service sensitive for time delay is processed with priority and non-real-time service is delayed a little, thereby a limited bandwidth can be used effectively.

### BACKGROUND OF THE INVENTION

1. Field of the Invention

The present invention relates to asynchronous transfer mode (ATM) communications, and more particularly to an apparatus and a method for controlling quality of service (QoS) of the ATM.

2. Background of the Related Art

An asynchronous transfer mode (ATM) network for performing B-ISDN typically provides multi-media services having various traffic characteristics such as voice, video and data. In order to meet prevailing communications demands, these networks must satisfy requests for different qualities of the services. Also, in an ATM network, traffic sources having varying characteristics require varying degrees of quality of service (QoS). To satisfy these requirements, new traffic control technologies have been developed. These include an approval procedure for a new call connection request, monitoring for legal usage in pre-connected call and assuring appointed QoS, and a policy for load generation, etc. Traffic controlling is closely related to network resource assignment, and thus a basic objective of traffic controlling is to protect the network and to achieve the functional objectives of the network.

Generally, in a system based on an asynchronous transfer mode, user information is divided based on a predetermined packet size, and a header, that is, destination information, is added to the divided packet to form a cell of fixed size. The generated cell is then transmitted to the intended destination.

A B-ISDN (broadband integrated services digital network) protocol reference model comprises a user plane for transmitting user information, a control plane for controlling connections, and a management plane for monitoring network. B-ISDN service may be classified into a variety of types. There is, for example, a constant bit rate (CBR) service and a variable bit rate (VBR) service, a real-time service and a non real-time service, and a connection-oriented service and connectionless service. Among those, the real-time service is the one which provides prompt response and concurrency. Representative examples of real-time service include visual communicating conference service, visual telephone service, etc. The data transmission service is an example of a non real-time service.

FIG. 1 shows a hierarchical structure of an ATM protocol. This protocol is based on an open systems interconnection (OSI) reference model which has 7 layers. The user plane of the ATM consists of 4 layers, namely a physical layer, an ATM layer, an ATM adaptation layer (AAL), and a higher layer, as shown in FIG. 1. QoS control is generally performed on the ATM layer.

The physical layer provides a transferring function for conveying ATM cells, and consists of a physical medium (PM) sub-layer and a transmission convergence (TC) sub-layer. The PM sub-layer provides the physical transmission path medium with a bit transmitting function, and provides functions such as generating and receiving a waveform of a signal corresponding to the medium, inserting and extracting bit information, transmission coding, and converting electricity-light, etc. The TC sub-layer generates and deletes a transmission frame for mapping on a payload of the ATM cell. A sender side inserts a synchronization pattern into the cell and transmits the cell after scrambling it in order to ensure bit sequence integrity (BSI). A receiving side makes an original cell form by de-scrambling the cell as delineating the cell.

The ATM layer is disposed on top of the physical layer and realizes ATM communication in accordance with an asynchronous transfer method. More specifically, the ATM layer performs functions which include multiple separating pf the ATM cell, selecting virtual channel and passage, and generating and deleting a cell header.

The AAL is located on top of the ATM layer and is responsible for cutting and transmitting information according to a certain length so as to correspond to a desired cell structure. The AAL performs functions which include absorbing a quantization effect generated when information is segmented, compensating for cell loss or error due to transmission error or congestion, and concealing an inherent operation of the ATM layer from the higher layer. The AAL assigns the functions to a segment and disassembly sub-layer (SAR) and a convergence sub-layer (CS).

The higher layer (or application layer) is the layer nearest to the user and may include, for example, a spreadsheet application and a word processor application. In general, the application layer does not provide other layers with any service.

The AAL is the layer is used for reassembling packet data transmitted from the higher layer into 28 bits and can be classified into 5 types (AAL-1^{˜} AAL-5). The AAL-2 provides a function of segmenting and reassembling user information, processes variations in cell delay, and processes lost or inserted cells. The AAL-2 also transmits user-service data unit (S-SDU) of real-time type at a speed of variable bit rate (VBR).

The AAL-5 is similar to the AAL3/4 which transmits a cell as connection-oriented or as connectionless. However, the AAL-5 simplifies the functions of the AAL3/4 and is suitable for high speed data communications. The difference between the AAL-5 and the AAL3/4 is that the multiplexing is not supported in the AAL-5. The ATM system may convert the AAL2 cell into the AAL5 cell, or convert the AAL5 cell into the AAL2 cell in order to increase efficiency of the data transmission.

FIG. 2 is a diagram showing formats of the AAL2 and AAL5 cells suggested by ITU-T. The format of the AAL2 is standardized in I.363.2 and I.366.1 of ATM-Forum, and the format of the AAL5 cell is standardized in I.363.5. When an AAL2 cell is converted into an AAL5 cell, the ATM system decomposes the AAL2 cell by ATM channels, and re-decomposes the cell by packets. In addition, when the decomposed data is re-assembled according to I.363.5 standards of the ATM-Forum and a new channel value is granted, the AAL 2 cell is converted into the AAL5 cell.

When an AAL5 cell is converted into the AAL2 cell, the ATM system converts the header information of the AAL5 cell and decomposes the AAL5 cell by channel information of respective headers. In addition, when the decomposed data and the converted header information are reassembled according to the I.363.2 and I.366.1 standards of the ATM-Forum, the AAL5 cell is converted into the AAL2 cell.

In proposed systems of the related art, link failure or traffic congestion is solved passively. That is, in case a link failure is generated, the problem is solved by duplexing the link. In the case of traffic congestion, the problem is solved by limiting the call. Also, in the related art systems, since QoS control is performed on the ATM layer, certain B-ISDN services cannot be used for QoS control. These services include the real-time service and the non-real-time service. More specifically, decomposition and reassembling of real-time data and non-real-time data are performed on the AAL, and therefore real-time data and non-real-time data cannot be managed as divided in the QoS controlling method of the related art ATM layer. Therefore, the QoS is degraded and the link failure or the traffic congestion cannot be dealt with actively.

### SUMMARY OF THE INVENTION

An object of the invention is to solve at least the above problems and/or disadvantages and to provide at least the advantages described hereinafter.

Another object of the present invention is to provide an apparatus and method which controls quality of service (QoS) of asynchronous transfer mode (ATM) communications in a layer different from an ATM layer.

It is another object of the present invention to provide an apparatus and method which performs QoS control in an ATM adaptation layer.

It is another object of the present invention is to provide an apparatus and a method which controls QoS in an ATM using services such as real-time service and non-real-time service.

To achieve these objects and other advantages of the present invention, there is provided an apparatus for controlling QoS of an ATM comprising a first processing unit converting received AAL5 type traffic into an AAL2 type traffic and then serving real-time AAL2 type traffic with priority, and a second processing unit for converting received AAL2 type traffic into AAL5 type traffic and after that, serving real-time AAL5 type traffic with priority.

The first processing unit comprise a first traffic measuring unit for applying a QoS controlling signal to a first receiving unit and a first transmitting unit, a first receiving unit outputting received AAL5 type traffic by segmenting it into the real-time traffic and the non-real-time traffic when the QoS signal is applied, a first buffer unit storing output traffic of the first receiving unit, and a first transmitting unit converting the stored traffic into AAL2 type, and serving the real-time traffic with priority, after the QoS signal is applied.

The second processing unit comprises: a second traffic measuring unit for applying a QoS control signal to a second receiving unit and to a second transmitting unit when a transmission link failure or a traffic congestion is generated, a second receiving unit outputting received AAL2 type traffic as segmenting it into real-time traffic and non-real-time traffic when the QoS control signal is applied, a second buffer unit storing output traffic of the second receiving unit, and a second transmitting unit converting the stored traffic into the AAL5 type and serving the real-time traffic when the QoS control signal is applied. The processing units further comprise token generators for generating token.

Also, to achieve the objects of the present invention, there is provided a method for controlling QoS of an ATM comprising a step of dividing traffic received in the receiving units into real-time traffic and non-real-time traffic and storing them in the buffer unit when a transmission link failure or a traffic congestion is generated, a step of converting the stored traffic into AAL2 type or into AAL5 type; and a step of serving real-time traffic with priority using a token among the converted traffic.

The foregoing and other objects, features, aspects and advantages of the present invention will become more apparent from the following detailed description of the present invention when taken in conjunction with the accompanying drawings.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a view showing hierarchy structure of an ATM;

FIG. 2 is a view showing formats of an AAL2 and an AAL5 cell suggested by ITU-T;

FIG. 3 is a view showing hierarchy structure of an ATM according to the present invention;

FIG. 4 is a block diagram showing a QoS controlling apparatus according to the present invention;

FIG. 5 is a flow chart describing a QoS controlling method according to the present invention;

FIG. 6A is a conceptual view illustrating basic concepts of the QoS controlling according to the present invention;

FIG. 6B is a conceptual view showing cell processing by QoS controlling apparatus when a link failure is generated on a transmission end; and

FIG. 6C is a conceptual view showing cell processing by the QoS controlling apparatus when a traffic congestion is generated on the transmission end.

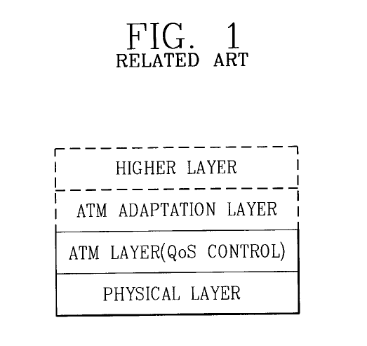

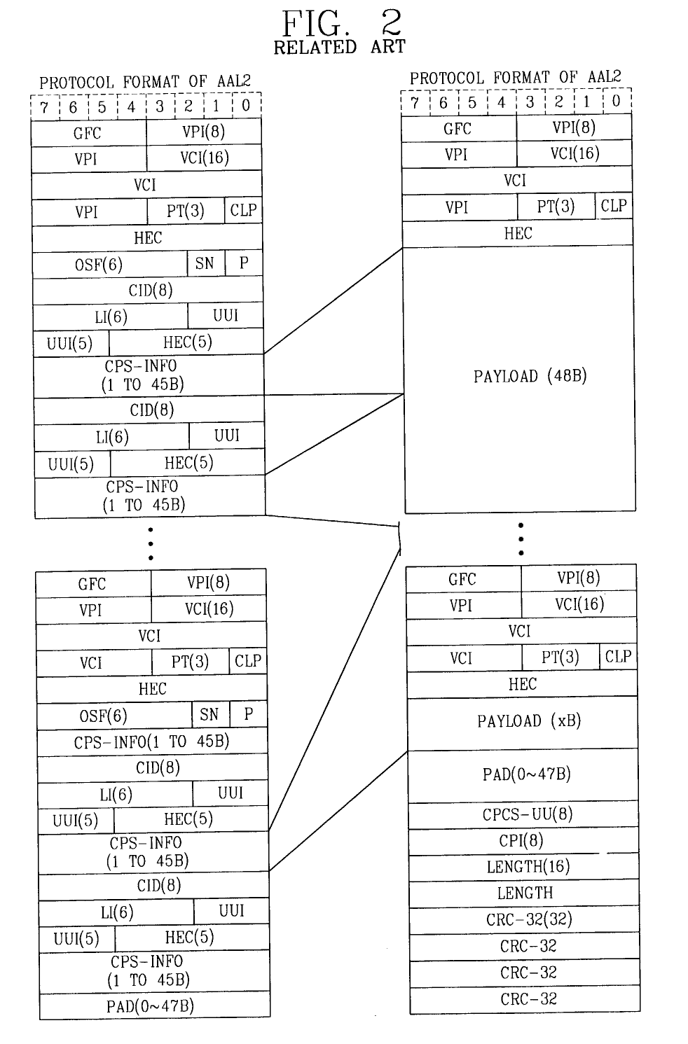

### DETAILED DESCRIPTION OF PREFERRED EMBODIMENTS

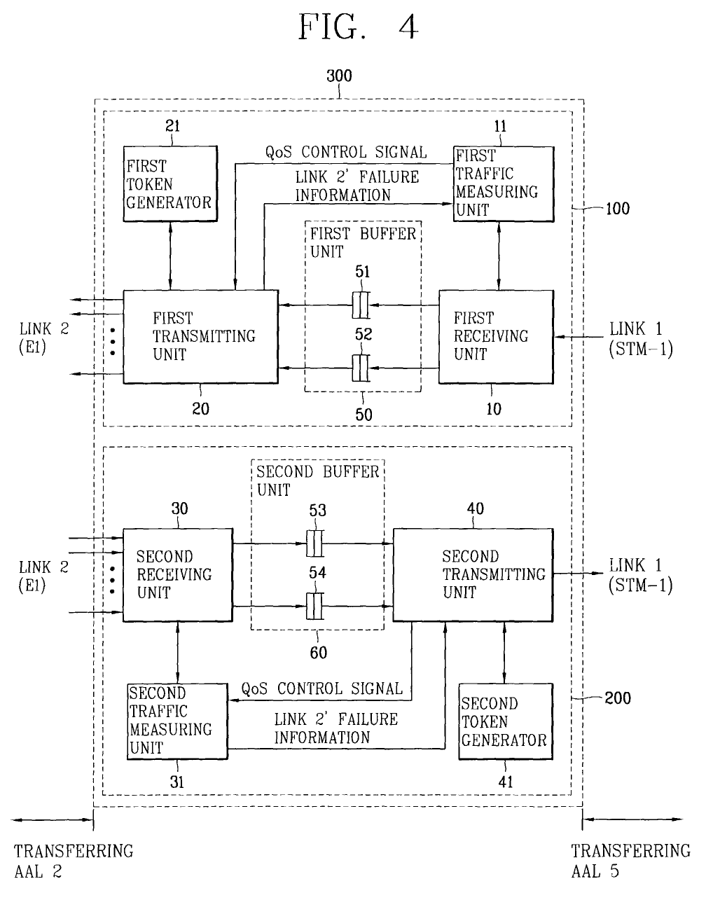

FIG. 4 is a block diagram showing an apparatus 300 for controlling quality of service (QoS) according to one embodiment of the present invention. The apparatus includes a first processing unit 100 which converts a received AAL5-type traffic into an AAL2-type traffic, and which serves real-time AAL2-type traffic with priority; and a second processing unit 200 which converts a received AAL2-type traffic into an AAL5-type traffic and which serves real-time AAL5 traffic with priority.

The first processing unit 100 includes a first receiving unit 10, a first traffic measuring unit 11 and a first transmitting unit 20. The first traffic measuring unit applies a QoS control signal to the first receiving unit 10 and to the first transmitting unit 20 when a transmission link failure or a traffic congestion is generated. The first receiving unit 10 segments received AAL5-type traffic into real-time traffic and non-real-time traffic when the QoS control signal is applied. A first buffer unit 50 stores output traffic from the first receiving unit 10, and the first transmitting unit 20 converts the stored traffic into the AAL2-type and serves the real-time traffic with priority when the QoS control signal is applied.

The second processing unit 200 includes a second receiving unit 30, a second traffic measuring unit 31, and a second transmitting unit 40. The second traffic measuring unit applies a QoS control signal to the second receiving unit 30 and to the second transmitting unit 40 when a transmission link failure or a traffic congestion is generated. The second receiving unit 30 outputs segments received from AAL2-type traffic into real-time traffic and non-real-time traffic when the QoS control signal is applied. A second buffer unit 60 stores output traffic of the second receiving unit 3, and a second transmitting unit 40 converts the stored traffic into AAL5-type traffic and serves the real-time traffic with priority when the QoS control signal is applied.

The processing units 100 and 200 further include token generators 21 and 41 for generating tokens.

Buffer units 50 and 60 are preferably First in First out (FIFO) buffers, and include buffers 51 and 53 for storing real-time traffic and buffers 52 and 54 for storing non-real-time traffic.

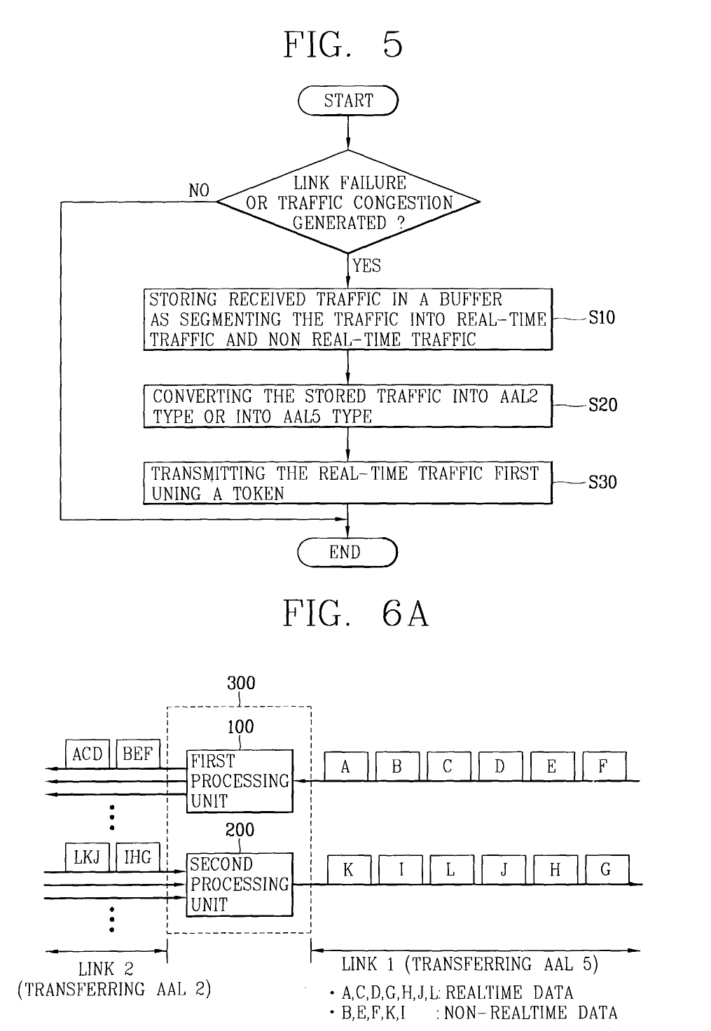

FIG. 5 is a flow chart describing a QoS controlling method according to one embodiment of the present invention. The method includes as an initial step dividing AAL-5 traffic received in receiving unit 10 into real-time traffic and non-real-time traffic and storing the divided traffic in buffer unit 50 when a transmission link failure or a traffic congestion is generated (S10). The receiving unit 30 performs a different function. Namely, unit 30 divides received AAL-2 traffic into real-time and non-real-time traffic and then stores this traffic in buffer 60. A next step includes converting the traffic stored into AAL2-type traffic, and converting the traffic stored in buffer 60 into AAL5-type traffic (S20). Next, the real-time traffic is served with priority using the token among the converted traffic (S30).

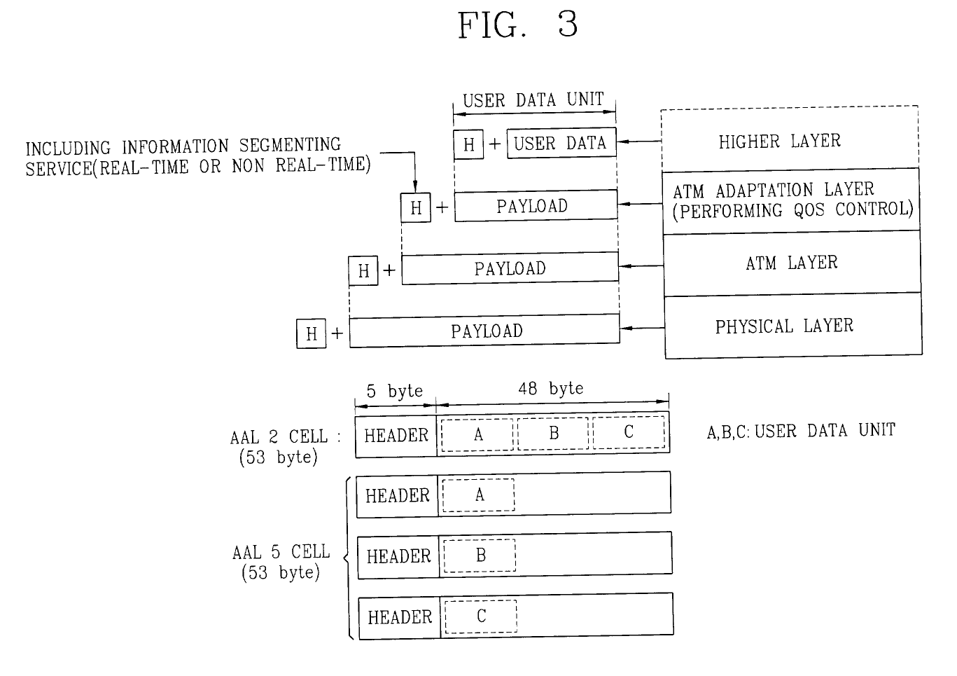

FIG. 3 is a diagram showing a hierarchical structure of the ATM and structures of an AAL2 cell and AAL5 cell respectively. The QoS controlling method according to one embodiment of the present invention is performed on an ATM adaptation layer.

As shown in FIG. 3, the AAL5 cell carries one user data unit on a payload. However, the AAL2 cell is multiplexed so as to carry one or more user data units on the payload. Generally, the user data carried on the AAL2 cell May have different service kinds (real-time or non-real-time) from each other, but the QoS controlling apparatus 300 according to the present invention preferably generates-an AAL2 cell which includes only real-time user data or only non-real-time user data. The real-time AAL2 cell is then transmitted with priority.

According to the related art method for performing QoS control in an ATM layer, AAL2 cells cannot be generated by service kinds, that is, by a real-time AAL2 cell or a non-real-time AAL2 cell. More specifically, information related to the service kind of the user data is stored on a header which is generated on an AAL layer, and therefore the service kind of the user data cannot be identified on the ATM layer.

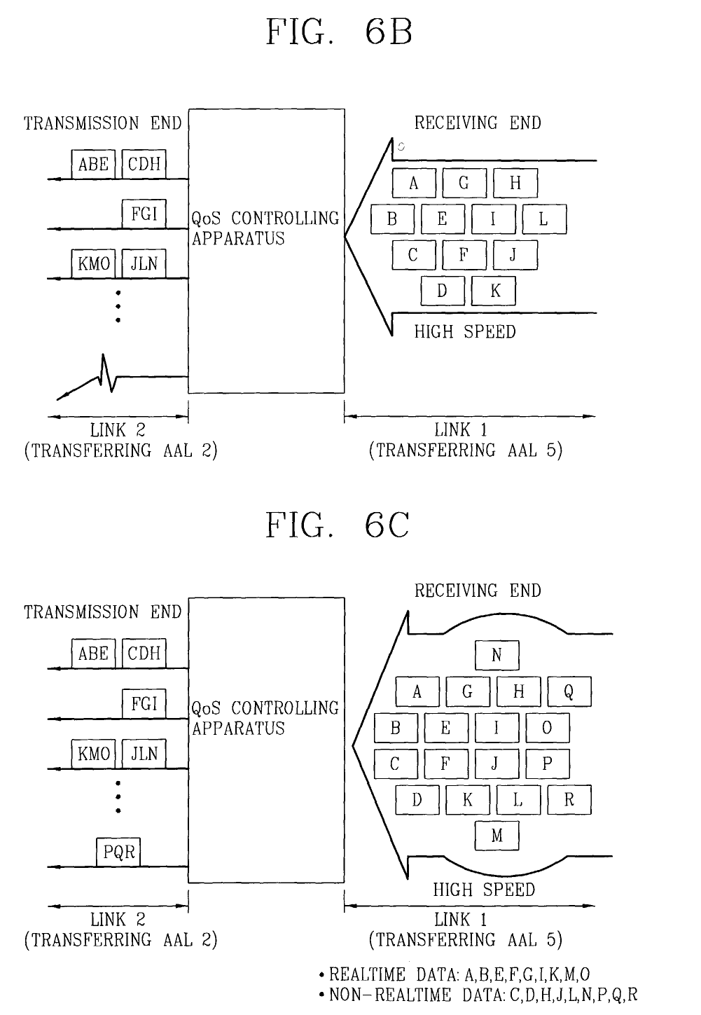

FIG. 6A is a conceptual diagram describing basic concepts of QoS control according to the present invention. FIG. 6B is a conceptual diagram illustrating cell processing by the QoS controlling apparatus when a link failure is generated on a transmission end. FIG. 6C is a conceptual diagram illustrating cell processing by the QoS controlling apparatus when a traffic congestion is generated on the transmission end.

The QoS controlling apparatus 300 according to the present invention is able to perform traffic control more effectively when one side of the QoS controlling apparatus is connected to a plurality of low-speed links (hereinafter, referred to as ‘link 1’, example: E1) which transfers the AAL2-type cells. The other side of the QoS controlling apparatus is connected to one high-speed link (hereinafter, referred to as ‘link 2’, example: STM-1) which transfers the AAL5 type cells. Link 1 preferably includes 16 E1 links so that it can to receive traffic of link 2 (STM-1).

According to one embodiment, the QoS controlling apparatus 300 according to the present invention relies on the first processing unit 100 to control the traffic transmission from link 1 to link 2, and relies on the second processing unit 200 to control traffic transmission from link 2 to link 1. Operations of the first processing unit 100 when the transmission link failure or the traffic congestion is generated will now be described with reference to FIGS. 3 through 5.

First, a case where a link failure is generated will be described.

If a failure is generated on one link of link 2, first transmitting unit 20 transmits failure generation information to traffic measuring unit 11. When traffic measuring unit 11 receives the failure information, traffic measuring unit 11 transmits a QoS control signal to the first transmitting unit 20 and to the first receiving unit 10.

The first receiving unit 10 which received the QoS control signal segments the AAL5 cell (or traffic) received through link 1 by service kinds (real-time service and non-real-time service), and stores them in FIFO buffers 51 and 52 respectively (S10). That is, the real-time AAL5 cell is stored in the real-time FIFO buffer 51, and the non-real-time AAL5 cell is stored in the non-real-time FIFO buffer 52.

On the other hand, first transmitting unit 20 which received the QoS control signal operates token generator 21, and converts the AAL5 cell in buffers 51 and 52 into the AAL2-type cell (S20). Then, real-time AAL2 cells and non-real-time AAL2 cells are generated.

The first transmitting unit 20 transmits the generated real-time AAL2 cell with priority using the token (S30). That is, QoS controlling apparatus 300 assigns bandwidth to the real-time service preferentially in order to prevent the transmission of real-time service traffic from being delayed, and grants the token to the non-real-time service traffic so that the non real-time service can be performed through remained bandwidth.

Next, the case where traffic congestion is generated will now be described.

If traffic congestion is generated on the transmission end, traffic measuring unit 11 recognizes it and transmits the QoS control signal to first transmitting unit 20 and to first receiving unit 10.

The first receiving unit 10 which received the QoS control signal segments the AAL5 cell (or traffic) received through link 1 by services and stores the segments in FIFO buffers 51 and 52 (S10). In addition, first transmitting unit 20 which received the QoS control signal operates token generator 21, and converts the AAL5 cell in buffers 51 and 52 into the AAL2-type cell (S20). And then, first transmitting unit 20 transmits real-time AAL2 cell with priority using the token (S30).

When the transmission link failure or the traffic congestion is generated, operations of the second processing unit 200 for performing the QoS controlling are same as those of the first processing unit 100. However, in the converting step (S20), the second processing unit 200 converts the AAL2 cell into the AAL5-type cell differently from the first processing unit 100.

As described above, the QoS controlling is performed on the ATM adaptation layer according to the present invention, and thereby, the QoS can be ensured for the multiplexed cell such as the AAL2 cell.

Also, when the transmission link failure or the traffic congestion is generated, the real-time service traffic and the non-real-time service traffic is segmented, and after that, the real-time service sensitive for the time delay is processed first and the non-real-time service is delayed by a small amount. As a result, the limited bandwidth can be used effectively.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. An apparatus for controlling quality of service (QoS) of an asynchronous transfer mode (ATM) system, comprising:
a first processing unit which converts received AAL5-type traffic into AAL2-type traffic, and thereafter, serves real-time AAL2-type traffic with priority; and
a second processing unit which converts received AAL2-type traffic into AAL5-type traffic, and thereafter serves real-time AAL5-type traffic with priority.

2. The apparatus of claim 1, wherein the first processing unit comprises:
a first traffic measuring unit which applies a QoS control signal to a first receiving unit and to a first transmitting unit when a transmission link failure or a traffic congestion is generated;
a first receiving unit which segments and outputs the received AAL5-type traffic into real-time traffic and non-real-time traffic when the QoS control signal is applied;
a first buffer unit which stores output traffic of the first receiving unit; and
a first transmitting unit which serves real-time traffic with priority after converting the stored traffic into AAL2-type traffic when the QoS control signal is applied.

3. The apparatus of claim 2, wherein the first processing unit further comprises a token generator for generating tokens.

4. The apparatus of claim 2, wherein the first transmitting unit performs prior service using a token.

5. The apparatus of claim 2, wherein the first buffer unit comprises:
a first buffer for storing real-time traffic; and
a second buffer for storing non-real-time traffic.

6. The apparatus of claim 5, wherein the first and the second buffers are First in First out (FIFO) buffers.

7. The apparatus of claim 1, wherein the second processing unit comprises:
a second traffic measuring unit which applies a QoS control signal to a second receiving unit and to a second transmitting unit when a transmission link failure or a traffic congestion is generated;
a second receiving unit which segments and outputs the received AAL2-type traffic into real-time traffic and non-real-time traffic when the QoS control signal is applied;
a second buffer unit which stores output traffic of the second receiving unit; and
a second transmitting unit which serves real-time traffic with priority after converting the stored traffic into AAL5-type traffic when the QoS control signal is applied.

8. The apparatus of claim 7, wherein the second processing unit further comprises a token generator for generating tokens.

9. The apparatus of claim 7, wherein the second transmitting unit performs prior service using a token.

10. The apparatus of claim 7, wherein the second buffer unit comprises:
a third buffer for storing real-time traffic; and
a fourth buffer for storing non-real-time traffic.

11. The apparatus of claim 10, wherein the third and the fourth buffers are First in First out (FIFO) buffers.

12. The apparatus of claim 1, wherein the first processing unit and the second processing unit perform QoS control on an ATM adaptation layer.

13. A method for controlling QoS of an ATM comprising:
storing AAL2-type and AAL5-type traffic received by a receiving unit and segmenting the traffic into real-time traffic and non-real-time traffic when a transmission link failure or traffic congestion is generated;
converting the stored AAL2-type traffic into AAL5-type traffic, or converting the stored AAL5-type traffic into AAL2-type traffic; and
serving real-time traffic with priority using a token among the converted traffic, in a QoS controlling apparatus of which one side is connected to an AAL5 transfer link and the other side is connected to an AAL2 transfer link.

14. The method of claim 13, wherein the buffer unit comprises:
a first buffer for storing real-time traffic; and
a second buffer for storing non-real-time traffic.

15. The method of claim 14, wherein the first and the second buffers are First in First out (FIFO) buffers.

16. The method of claim 13, wherein at least the converting step is performed for QoS control on an ATM adaptation layer.

17. A method for controlling communications in a ATM system, comprising:
detecting a communications error; and
performing quality of service (QoS) control on an ATM adaption layer of the system.

18. The method of claim 17, wherein said communications error includes a traffic link failure.

19. The method of claim 17, wherein said communications error includes traffic congestion.

20. The method of claim 17, further comprising:
segmenting incoming traffic into real-time traffic and non-real-time traffic, said incoming traffic corresponding to a first type of AAL traffic; and
converting at least the real-time traffic into a second type of AAL traffic.

21. The method of claim 20, wherein the first type of AAL traffic is AAL-2 traffic and the second type of AAL traffic is AAL-5 traffic.

22. The method of claim 20, wherein the first type of AAL traffic is AAL-5 traffic and the second type of AAL traffic is AAL-2 traffic.

23. The method of claim 20, further comprising:
serving the real-time second type of AAL traffic with priority.

24. The method of claim 23, wherein the serving step is performed based on a token from a token generator.

25. The method of claim 17, further comprising:
segmenting incoming traffic into real-time traffic and non-real-time traffic, said incoming traffic corresponding to a first type of AAL traffic; and
converting the real-time traffic and non-real-time traffic into a second type of AAL traffic.

26. The method of claim 25, further comprising:
serving the real-time and non-real-time second type of AAL traffic, wherein the real-time second type of ALL traffic is served with priority over the non-real-time second type of AAL traffic.

27. The method of claim 26, wherein the serving step is performed based on a token from a token generator.
